(19) United States
(12) Patent Application Publication
(10) Pub. No.: US 2011/0029998 A1
(43) Pub. Date: Feb. 3, 2011

(54) IN-FLIGHT VIDEO ENTERTAINMENT SYSTEM

(76) Inventor: Man Pak Yip, Redwood City, CA (US)

Correspondence Address: CHRISTIE, PARKER & HALE, LLP, PO BOX 7068, PASADENA, CA, 91109-7068, US

(21) Appl. No.: 12/520,985

(22) PCT Filed: Jun. 1, 2009
(86) PCT No.: PCT/US09/45884

§ 371 Date: Oct. 12, 2010

Related U.S. Application Data
(60) Provisional application No. 61/057,630, filed on May 30, 2008.

(51) Int. Cl. H04H 60/32; H04N 7/10

(52) U.S. Cl. 725/14; 725/34

(57) ABSTRACT

An in-flight entertainment system includes a flight system server and seat video display units connected to the flight system server via a network. Each seat video display unit has a video display unit and a user input and is situated with a passenger seat on an airplane. The flight system server records interactions between passengers using the seat video display units and the flight system server during a flight. The flight system server displays advertisement chosen based on the recorded interactions on the video display units during the flight.

### BACKGROUND OF THE INVENTION

This invention relates to aspects of an in-flight entertainment (“IFE”) system situated on an airplane for implementing IFE services at each passenger seat. This invention also relates to a particular aspect of IFE content that coordinates interactive online socializing services.

### SUMMARY OF THE INVENTION

This invention relates to aspects of an in-flight entertainment (“IFE”) system, specifically a fault-tolerant Ethernet network situated on an airplane for implementing IFE services at each passenger seat. This invention also relates to a particular aspect of WE content that coordinates interactive online socializing services based on personal profiles dynamically assembled from passengers' activities during the flight.

In one embodiment, an in-flight entertainment system includes a flight system server and seat video display units connected to the flight system server via a network. Each seat video display unit has a video display unit and a user input and is situated with a passenger seat on an airplane. The flight system server records interactions between passengers using the seat video display units and the flight system server during a flight. The flight system server displays advertisement chosen based on the recorded interactions on the video display units during the flight.

### BRIEF DESCRIPTION OF THE DRAWINGS

FIG. 1 is a block diagram of an in-flight entertainment system according to an embodiment of the invention.

FIG. 2 is a block diagram of an in-flight entertainment system according to another embodiment of the invention.

FIG. 3 is a block diagram of an in-flight entertainment system according to another embodiment of the invention.

FIG. 4 is a block diagram of an in-flight entertainment system according to another embodiment of the invention.

FIG. 5 is a block diagram of an in-flight entertainment system according to another embodiment of the invention.

FIG. 6 is a block diagram of an in-flight entertainment system according to another embodiment of the invention.

FIG. 7 is a block diagram of an in-flight entertainment system according to another embodiment of the invention.

FIG. 8 is a block diagram of an in-flight entertainment system according to another embodiment of the invention.

FIG. 9 is a collection of screen shots of a user interface of an in-flight entertainment system according to an embodiment of the invention.

### DETAILED DESCRIPTION OF THE INVENTION

Prime considerations in implementing an IFE network system are system reliability and fault tolerance, and ease of repair once a failure occurs. These aspects may be important because at least some of the network hardware will typically be located in exposed places in the cabin or under passenger seats, where it can be repeatedly kicked or jostled by passengers and their baggage. It is thus expected that networking components will fail from time to time; when this occurs, it is beneficial if such failure does not affect any passenger's IFE experience, or at least if the number of passengers affected by such failure is kept to a minimum. Further, quick and easy in-field replacement of failed hardware at any of multiple remote repair depots and without the remote repair depot having to coordinate with a central maintenance authority is advantageous. The IFE network topologies disclosed here promote these considerations.

In many embodiments of this invention, WE services are provided to each passenger seat in an airplane by use of individual IFE client devices, also known as Seat Video Display Units (“SVDU”). Each IFE client/SVDU includes a display unit located in front of and facing the seat, and a control unit manipulable by the passenger in or at that seat. In most cases, the display unit of the IFE client is located in the seatback of the seat in front of the targeted passenger seat. Often, in these cases, the control unit of the IFE client is also located in the seatback of the seat in front of the targeted passenger seat. However, in locations such as the first row of a cabin or compartment where there is no seatback in front of the targeted seat or when there is a large separation between rows of seats, the display unit, the control unit, or both units of the IFE client may be located in another structure such as a bulkhead in front of the seat or attached to a swing out arm that is stowed in a seat armrest. Where necessary, the IFE client can be housed in a portable or removable stand-alone unit that attaches to or is positioned in front of the targeted seat.

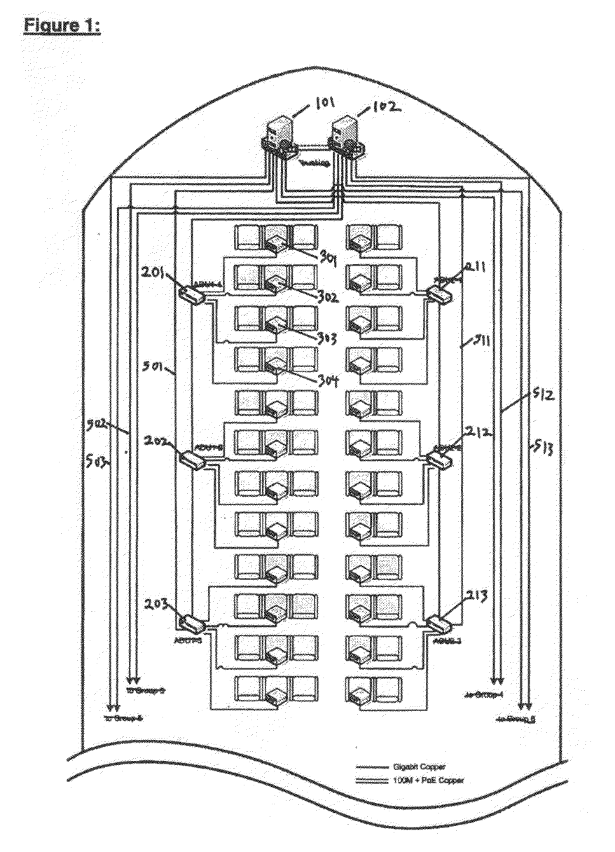

All content of the IFE system is stored in and channeled through at least one Content Server Unit (“CSU”), situated aboard the airplane. It is preferable to use at least two CSUs, so that a single-point failure within a lone CSU will not cripple the entire system. However, the second CSU (or multiple additional CSUs) need not be configured as a dormant, redundant spare to the first CSU, but rather can be put to more beneficial use to handle the data traffic load for a different portion of the airplane cabin while the first CSU handles its own portion of the cabin. FIGS. 1 through 8 show two CSUs 101 and 102 sharing the data transfer load for an entire airplane. Due to the separate user services involved, typically separate group networks are served by the CSUs for each section or class of seats, such as first class, business, or coach. The figures illustrate six such group networks, each group comprising twenty-four to thirty-six seats, for a total of 180 seats.

Data traffic from the CSUs is networked to the IFE clients through two intermediate distribution layers, comprising, first, a number of Area Distribution Units (“ADUs”), connected to the CSUs, each ADU handling multiple rows of seats, and second, a number of seatboxes in turn connected to the ADUs, each seatbox typically handling two to three seats. A seatbox is typically located in or under a passenger seat, and handles the IFE Clients in that particular grouping of seats in that row. It is typical to have a separate seatbox for the seat grouping of that row on each side of the aisle, and to have multiple seatboxes where multiple aisles separate the seats in that row into three or more groupings. Many of the embodiments of this invention implement a physical cabling topology that includes redundant or alternative cabling links between various network nodes or hardware. The network chooses between which of these alternative links to activate by using a spanning tree protocol (“STP”), for example according to the IEEE 802.1D standard. In some instances it may be beneficial to modify the standard STP algorithm where it would otherwise cause too many of the downstream hardware devices to route their data traffic through the same upstream device and overburden it.

The ADUs and the seatboxes are typically Ethernet switches. ADUs are typically similar in construction to seatboxes, and in some embodiments are identical in construction, allowing the same hardware to be used as either an ADU or a seatbox and thus allowing the same hardware to be stocked for replacement in the event either an ADU or a seatbox fails.

The CSUs are typically networked to the ADUs using network connections providing sufficient bandwidth, such as 1000BASE-T for example, according to the IEEE 802.3ab standard, which provides for gigabit Ethernet service over category 5 or better copper wiring using all four pairs of wires. The ADUs are in turn often networked to the seatboxes using lower bandwidth network connections, such as 100BASE-TX, according to the IEEE 802.3u standard, that provides for 100 megabit service, also over category 5 or better copper wiring, but using only two of the four pairs of wires. While the standards for 1000BASE-T and 100BASE-TX specify category 5 or better cabling, 1000BASE-TX network connections are less tolerant of improperly installed wiring and are often implemented using category 5e or 6 cabling. As 100BASE-TX only uses two pair of the four pairs of wires in typical category 5, 5e, or 6 cabling, in implementations using 100BASE-TX, one standard cable may be used to provide two separate 100BASE-TX connections between the ADUs and the seatboxes, so that potential 200 megabit service is provided and 100 megabit service is maintained even if one of the pairs of wires (or both pairs of one of the 100BASE-TX connections) is damaged. In other embodiments, non-standard category 5 or better network cable that contains two pairs of wires instead of the typical four pairs is used for the 100BASE-TX connection, reducing the weight and diameter of these cables. However, in some cases, category 5e or 6 cabling typically used in 1000 Bases-T networks is used to connect the ADUs to the seatboxes, for example, to reduce labor cost and potential error in installation due to the use of two different types of cable. Use of a copper medium allows use of a Power over Ethernet protocol, for example according to the IEEE 802.3af standard, so that separate power cables to the seatboxes are not required for powering them. In some embodiments, such as where power is available at or near the seatbox already (such as power outlets for laptops or power for lighting typical armrest controls), optical cable is used instead of copper, for reasons such as weight savings, speed, and reduced electromagnetic field generation.

In the embodiments of this invention, topologies improving on simple hierarchical data distribution are employed to improve fault tolerance. One such embodiment is disclosed in FIG. 1. Two CSUs 101 and 102 serve the two sets of shown daisy-chained ADUs, namely, daisy-chain 501 serving ADUs 201, 202, and 203 on one side of the aisle in a particular cabin, and daisy-chain 511 serving ADUs 211, 212, and 213 on the other side of the aisle in that cabin. In addition, the two CSUs simultaneously serve other group networks in other cabins or sections using daisy-chains 502, 503, 512, and 513. The use of a daisy-chain between the ADUs, which loops to a different CSU at each end rather than a single-ended distribution line from a CSU, improves fault tolerance against CSU failures, ADU failures, and cable link failures. For example, in normal operation, CSU 101 may be serving ADUs 201-203 through daisy-chain 501 and be serving ADUs 211-213 through daisy-chain 511, but if CSU 101 should fail, CSU 102 can serve those same ADUs through its connection to the other end of daisy-chains 501 and 511, with no interruption of data service to any of those ADUs. As another example, a failure in ADU 202, will not affect data service to ADU 201 which will continue to receive data from CSU 101, and will not affect data service to ADU 203 which will begin to receive data service from CSU 102 through the connection at the other end of daisy-chain 501. As still another example, a failure in the cable link between ADU 201 and ADU 202 will not affect data service to any of ADUs 201-203, since ADU 201 which will continue to receive data from CSU 101 and ADUs 202 and 203 will begin to receive data service from CSU 102 through the connection at the other end of daisy-chain 501. However, as ADU 201 in this topology is the lone network link supplying the four seat boxes 301 through 304, and thus the twelve IFE Clients they serve, the failure of ADU 201 will interrupt IFE service to twelve passengers (the passenger seats shown in the drawings represent seats served by an SVDU rather than a seatback that may house all or part of an SVDU).

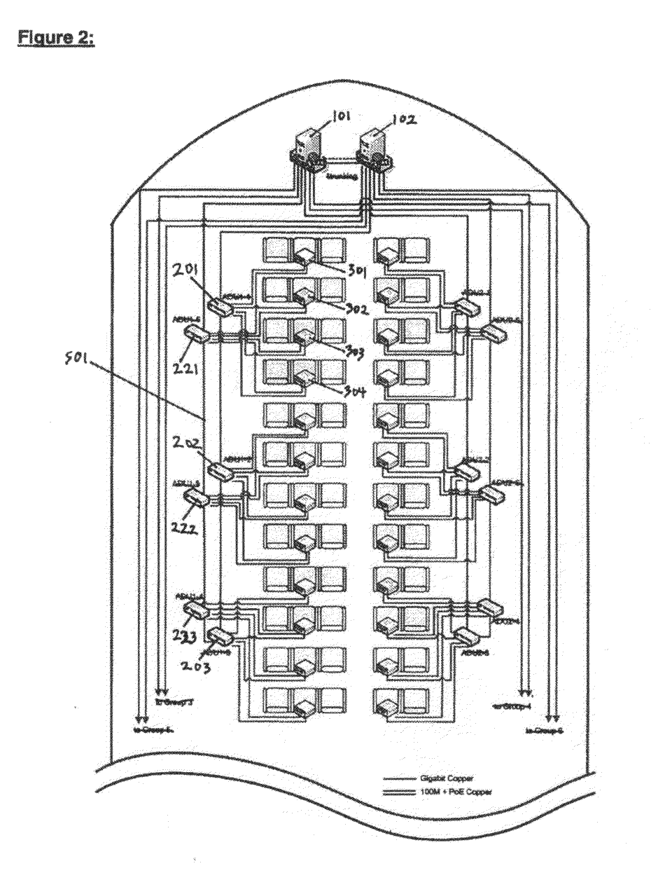

In the embodiment shown in FIG. 2, daisy-chain 501 served by CSUs 101 and 102 includes not only ADUs 201, 202, and 203 but also redundant ADUs 221, 222, and 223. The seatboxes in this embodiment have two upstream data connections: ADUs 201 and 221 each can supply seatboxes 301-304 with the same data traffic, forming a redundant pair. ADUs 202 and 222 and ADUs 203 and 223 form similar redundant pairs. If ADU 201 fails, ADU 221 continues to supply data service and none of the seatboxes 301-304 or their served IFE Clients experience an interruption of service.

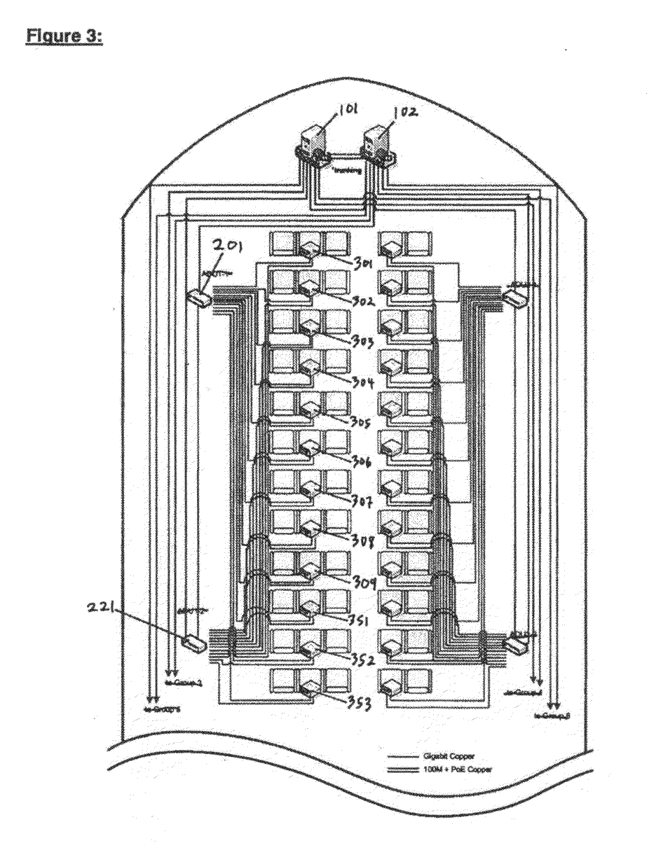

In the embodiment shown in FIG. 3, the number of ADUs is reduced by using ADUs that have a large number of downstream connections. As in FIG. 2, daisy-chain 501 served by CSUs 101 and 102 includes ADU 201 and redundant ADU 221. The seatboxes in this embodiment have two upstream data connections. ADUs 201 and 221 each can supply seatboxes 301-309 and 351-353 with the same data traffic, forming a redundant pair. Seatboxes 301-309 and 351-353 are normally served by ADU 201, but in the event of ADU 201's failure they are served instead by ADU 221. This embodiment has benefit of reducing overall weight and the number of pieces of network hardware devices located in the cabin, while retaining fault tolerance with respect to ADU failure.

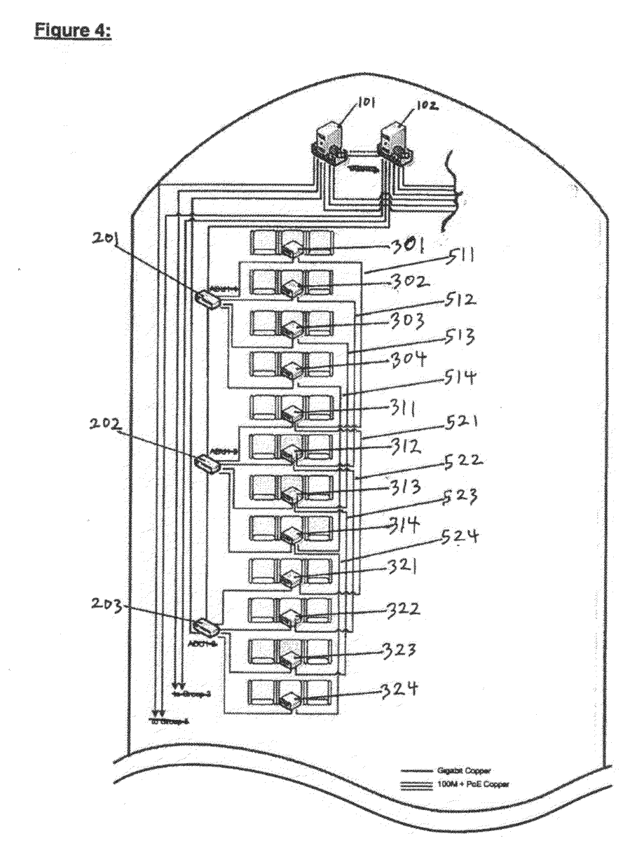

In the embodiment shown in FIG. 4, fault tolerance with respect to ADU failures is provided by daisy-chaining together seatboxes from groups served by different ADUs. The seatboxes in this embodiment have either two or three upstream data connections. As shown in the figure, ADU 201 serves seatboxes 301-304, ADU 202 serves seatbox 311-314, and ADU 203 serves seatboxes 321-324. Beyond this, seatboxes 301, 311, and 321 are daisy-chained to each other through cable links 511 and 521, as are seatboxes 302, 312, and 322 through cable links 512 and 522, seatboxes 303, 313, and 323 through cable links 513 and 523, and seatboxes 304, 314, and 324 through cable links 514 and 524. If, for example, ADU 201 should fail, seatboxes 301-304 will receive data service through their respective daisy-chain connections from other seatboxes instead, and thus service to those seatboxes will not be interrupted. In the event of an ADU failure, any of ADUs 201, 202, and 203 may be called on to serve the seatboxes formerly served by the failed ADU. Thus each of these ADUs must be capable of serving any of the twelve daisy-chained seatboxes and any of the thirty-six IFE Clients associated with those twelve seatboxes.

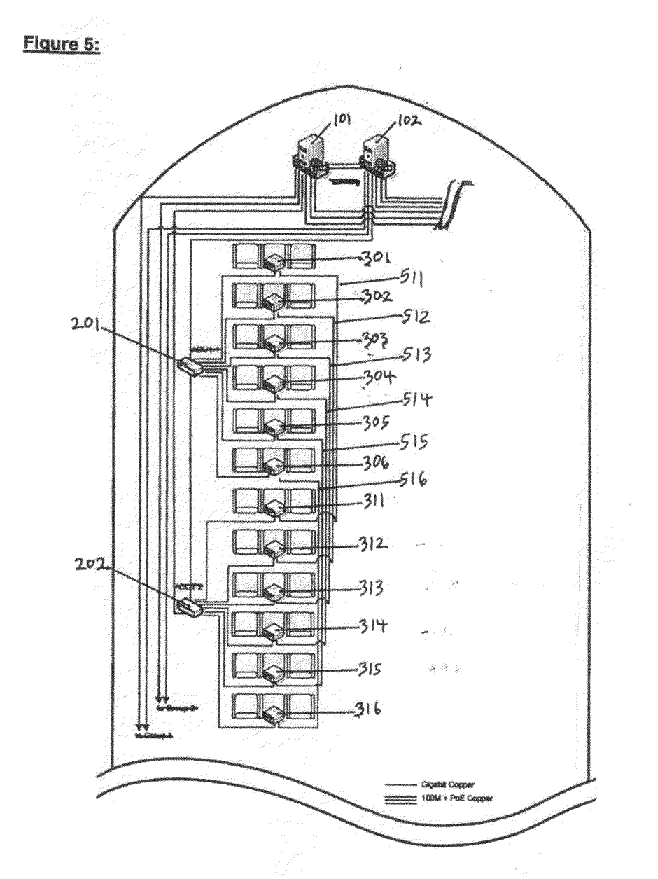

The embodiment shown in FIG. 5 is similar to that shown in FIG. 4, with fault tolerance with respect to ADU failures being provided by daisy-chaining seatboxes from groups served by different ADUs, but with each ADU serving six seatboxes instead of four. This embodiment has a benefit of reducing overall weight and number of network hardware located in the cabin. The seatboxes in this embodiment have two upstream data connections and each of seatboxes 301-306 is daisy-chained to seatboxes 311-316, respectively, through cable links 511-516. ADU 201 and 202 in this embodiment must be capable of serving any of the twelve daisy-chained seatboxes 301-306 and 311-316, thus serving any of the thirty-six IFE Clients associated with those twelve seatboxes.

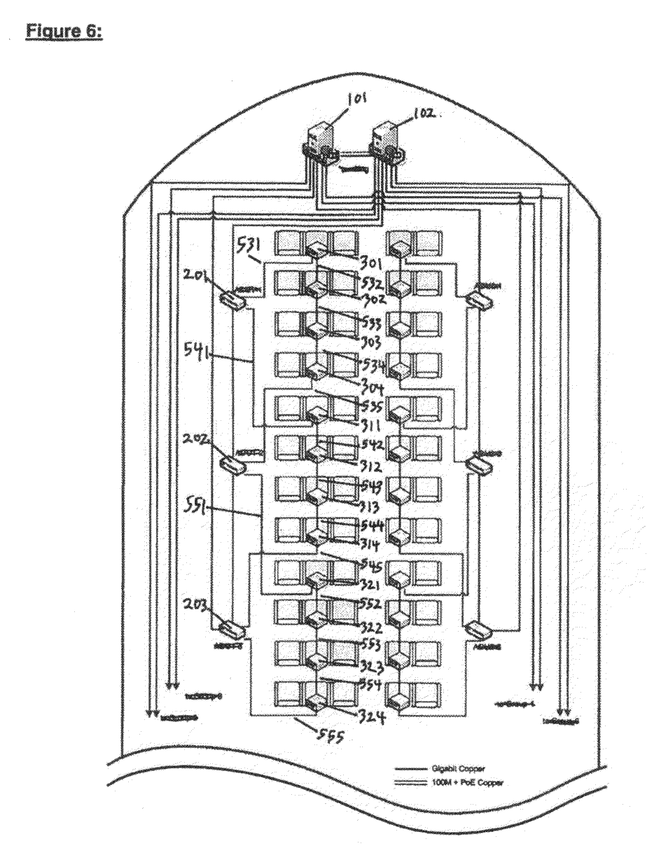

The embodiment shown in FIG. 6 uses daisy-chaining of seatboxes between multiple ADUs to achieve fault tolerance with respect to ADU failures. Each of a plurality of sets of four seatboxes is daisy-chained between two different ADUs, such as seatboxes 301-304 being daisy-chained between ADU 201 and ADU 202 using cable links 531-535, seatboxes 311-314 being daisy-chained between ADU 201 and ADU 203 using cable links 541-545, and seatboxes 321-324 being daisy-chained between ADU 202 and ADU 203 using cable links 551-555. If, for example, ADU 201 should fail in this embodiment, seatboxes 301-304 will continue to be served by ADU 202, seatboxes 311-314 will continue to be served by ADU 203, and no seatbox and no IFE Client will experience an interruption of service. If, within a particular daisy-chain among seatboxes, a seatbox fails, there will be no interruption of service to other seatboxes in that daisy-chain. For instance, if seatbox 302 fails, seatbox 301 will continue to receive data services from ADU 201 and seatboxes 303 and 304 will continue to receive data services from ADU 202, with no interruption of data services to any of them. Further, if a cable connection within a daisy-chain fails, the loop to multiple ADUs assures there will be no interruption of service at all. For instance, if cable connection 533 between seatbox 302 and seatbox 303 should fail, seatboxes 301-302 will continue to receive data services from ADU 201 through links 531 and 532, and seatboxes 303 and 304 will continue to receive data services from ADU 202 through links 534 and 535, with no interruption of data services to any of these seatboxes.

It should be further apparent that where the networking data links in any of the above embodiments would provide data services directly or redundantly to a seatbox, they would also provide power directly or redundantly to that seatbox using a Power over Ethernet protocol in embodiments where copper wire is used for the network connections.

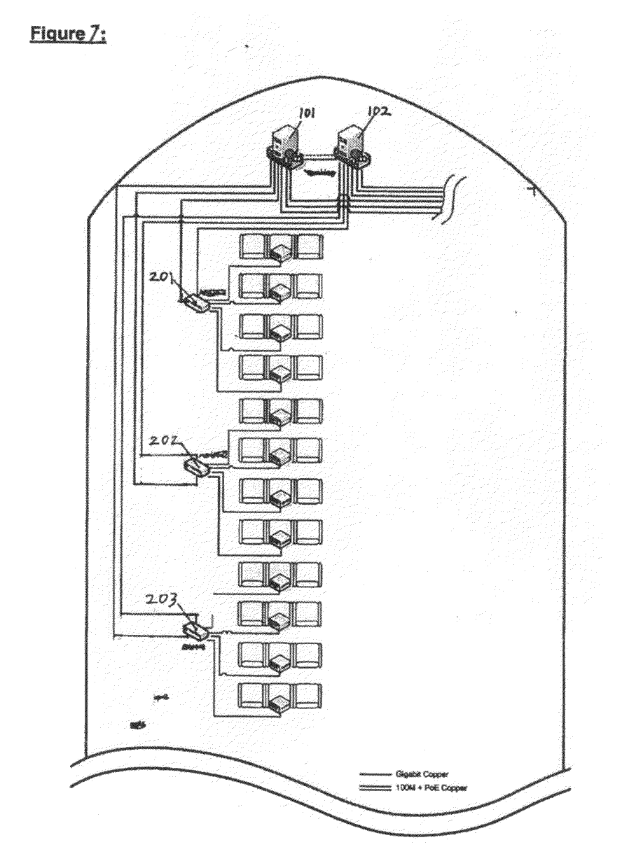

Although each of FIGS. 1-6 depict a dual-CSU daisy-chain to mitigate CSU failures, other fault tolerance strategies similar to those disclosed above for mitigating ADU failures can also be used to mitigate CSU failures. In the embodiment shown in FIG. 7, each of CSU 101 and 102 connects directly to ADUs 201, 202, and 203. Each of the ADUs in this embodiment has two upstream data connections. As with the daisy-chain configuration, if either CSU fails, all ADUs can be served from the surviving CSU without an interruption of data service.

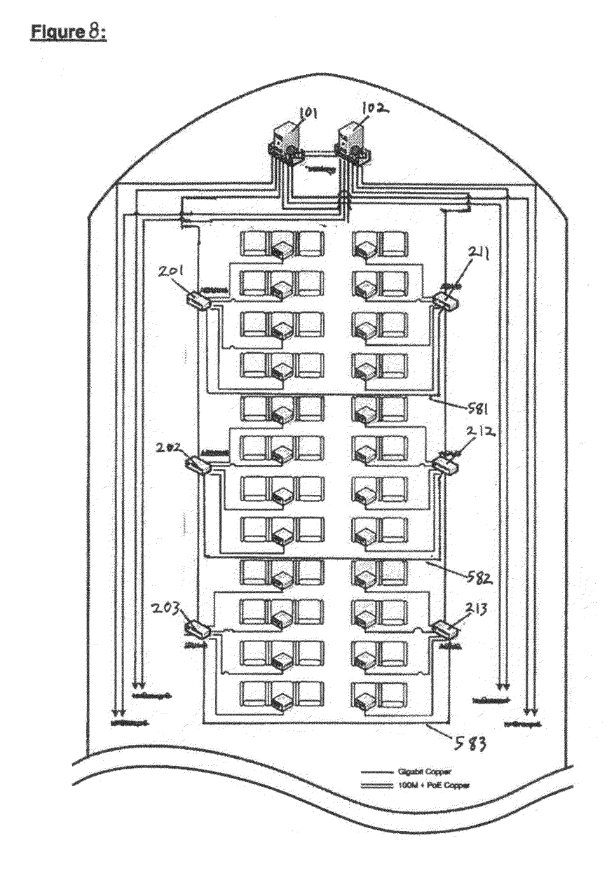

In the embodiment shown in FIG. 8, fault tolerance with respect to CSU failures is provided by daisy-chaining ADUs from groups served by different CSUs to each other. The ADUs in this embodiment have two upstream data connections. In the figure, CSU 101 serves ADUs 201, 202, and 203, while CSU 102 serves ADUs 211, 212, and 213. Beyond this, ADUs 201 and 211 are daisy-chained by cable link 581 to each other, as are ADUs 202 and 212 by cable link 582 and ADUs 203 and 213 by cable link 583. If, for example, CSU 101 fails, ADUs 201-203 will receive data service through their respective daisy-chain connections from ADUs 211-213 instead, and data service to ADUs 201-203 will not be interrupted.

It can be seen that any of the fault tolerant topologies disclosed herein to mitigate ADU failures can be combined with almost any of the fault tolerant topologies disclosed herein to mitigate CSU failures, in a mix-and-match fashion, to achieve combined fault tolerance against failures of either an ADU or a CSU. For example, the various topologies may be combined to reduce overall or per seat average downtime depending on variations in failure statistics and expectations, repair expense, and repair downtime between different types of components and connections in the system.

Ease of repair is promoted by interchangeability and uniformity of the networking hardware. In addition to the option of complete interchangeability of ADUs and seatboxes as disclosed above, turnaround of repair is shorter if replacements for failed networking hardware do not require pre-programming or extensive pre-configuration, either for themselves or for the network, before being installed. The capability to install a piece of hardware without special pre-programming is sometimes known as “plug and play” capability. Such plug and play capability can be implemented, for example, in the area of network component naming or identity. Network components require a unique identifier in order to function within the network, such identifier typically taking the form of a Domain Name Service (“DNS”) name or an Internet Protocol (“IP”) address. The network must be able to recognize the identity of or assign an identity to each piece of network hardware without having multiple pieces of network hardware sharing an identity. This can be accomplished without hardware pre-programming or pre-configuration if the network identifier for a piece of hardware can be assigned on the fly by the network, based, for example, on the hardware device's location within the network, in which case a unit replacing a failed hardware unit will be assigned the same network identifier on the fly by the network as the network identifier of the unit it replaced.

Plug and play capability can be implemented by use of network configuration protocols promulgated by the CSU. In one embodiment, the CSU uses a topology discovery protocol to build a network topology database. The database information is stored on the server, which also acts as a DNS server and as a Dynamic Host Configuration Protocol (“DHCP”) server. A hardware device upon installation on the network generates a DHCP request to the server, to which the server responds by assigning a dynamic IP address to the device using standard DHCP procedures. The device's unique hard-coded Media Access Control identifier is then used to associate the assigned IP address within the server's topology database with a location-based DNS name, such as in the form [seat number].[airplane tail number].net, for example seat1A.N362AA.net, by which the device may thereafter be accessed from anywhere in the network. In a system using multiple CSUs, the topology database is copied and shared among the various CSUs.

In another embodiment of the location-based identifier, a hardware device can be assigned a fixed IP address based on the device's location. This can be implemented, for example, by the server intercepting a hardware device's DHCP request and appending DNS name information to it before passing the request to the DHCP server process. Armed with this extra DNS name information, the DHCP server is then able to determine and grant to the requesting hardware device a fixed, location-specific IP address. Among other things, this enables multiple DHCP servers on the aircraft to share a common IP address pool.

One aspect of the invention is directed to IFE services featuring a particular kind of interactive communication and socializing service, including real-time interactive messaging commonly known as “chat.” Chat services are well-known on the Internet, and an airplane passenger can chat with others on the Internet using IFE services. Beyond this, however, the IFE environment provides special opportunities for modes of chat unique to the in-flight experience. During the flight, a passenger may wish to chat with other passengers on the same flight, or even on other concurrent flights. This represents an opportunity to make new friends and to pass the time in flight with others who similarly find themselves with the out-of-routine spare time occasioned by flying on an airplane.

The passenger desiring to communicate with other passengers must, however, overcome the social obstacle of determining whom to chat with, and who would be interested in chatting with him or her. Interpersonal bonds are often formed based on shared interests, and the IFE system can allow a passenger to manually assemble a personal profile of his or her interests to be made available to other passengers for purposes of finding chat partners, such as by answering profiling survey questions. However, many passengers will not be interested in committing this much effort simply for short-term benefits during a few-hour flight. To answer this challenge, an embodiment of this invention is directed to automatic assembly of a profile of interests for a passenger based on that passenger's interactions with the IFE system itself.

For example, in an embodiment of this invention, though the use of Intelligent Agent software, the IFE system tracks which passengers have currently selected, or at some time during the flight have selected, a particular audio track, on-demand song or movie, information feature, advertisement, or category of such. The system then, using Chat Application software, gives to those passengers the ability to establish a chat connection with other passengers who have made the same or similar WE selections. The system, having recorded their in-common selection of that WE feature as a potential common interest, can disclose to these passengers that they have a starting topic for their chat. This common interest profile system may have multiple levels, keeping track of passengers who have selected multiple IFE features in common. This system may also be augmented by other interest-stirring features such as poll questions or current news features keyed to the item selected in common and retrieved from Internet news databases. The system may, as well, use this common interest profile in conjunction with Message Board Application software to establish and/or promote electronic message boards on various topics to which passengers may post messages and read the posted messages of others, or to direct advertisements or content recommendations to the profiled passenger.

An embodiment of the common interest communications system disclosed above is thus implemented using a plurality of WE Clients with Display Unit and Control Unit located in proximity to passenger seats for airplane passengers; a network to which at least one of the WE Clients is connected, the network comprising at least one IFE Server, an Intelligent Agent computer program implemented on at least one IFE Client or at least one WE Server, a log record implemented on at least one WE Client or at least one IFE Server, and a Chat Application computer program or a Message Board Application computer program implemented on at least one IFE Client or at least one IFE Server. Wherein the Intelligent Agent obtains from at least one IFE Client or at least one IFE Server information regarding at least one IFE item selection made by at least one of the airplane passengers or personal profile information entered by or authorized for release by at least one of the airplane passengers, and uses at least one piece of the information to propose or facilitate communication among a plurality of the airplane passengers using the Chat Application or the Message Board Application.

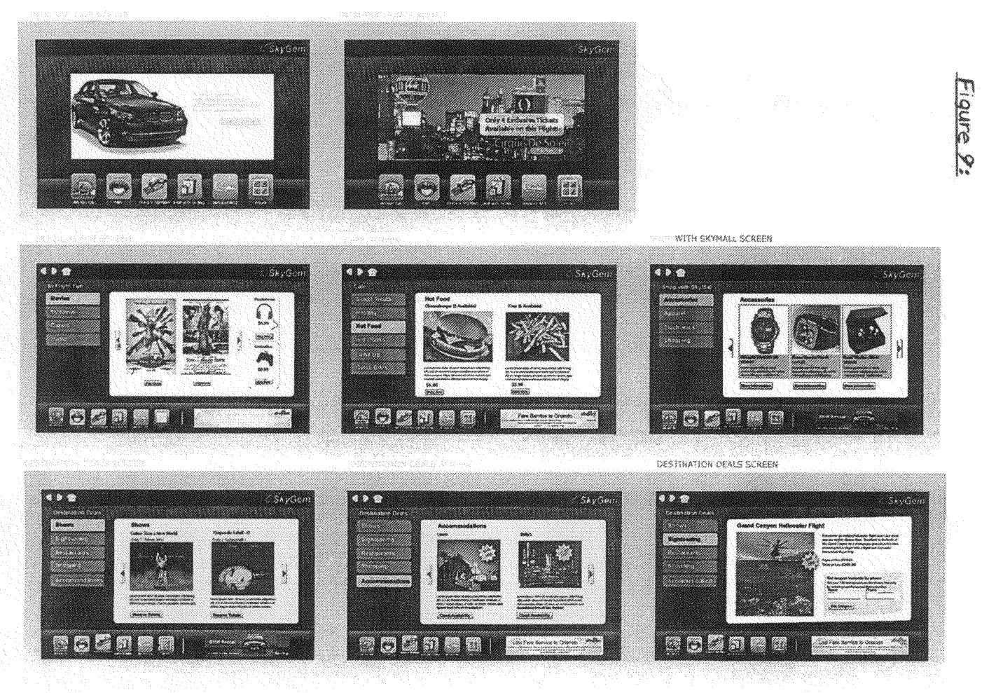

In many embodiments of the invention, the IFE system also includes other user interface features or user services, such as advertisements and seat based commerce services. FIG. 9 depicts several screen shots showing advertisements and various stages of shopping and commercial transactions. In some embodiments, advertisements or product offers are chosen based on the passenger's individual interaction with the IFE system on that or other flights (if there is a login feature that identifies the passenger to the IFE system). In other embodiments, advertisements or product offers are also chosen based on the interactions of other passengers on the same flight with the IFE system or interactions of passengers on previous flights on the same route as the current flight.

What is claimed is:

1. An in-flight entertainment system comprising:
a flight system server,
a plurality of seat video display units connected to the flight system server via a network, each seat video display unit comprising a video display unit and a user input, each seat video display unit for associate with a passenger seat on an airplane;
wherein the flight system server is configured to record interactions between users of the seat video display units and the flight system server during a current flight; and
wherein the flight system server is further configured to display an advertisement on at least one of the video display units during the current flight, the advertisement chosen based on the recorded interactions.

2. The system of claim 1 wherein:
the flight system server is further configured to allow communication between a plurality of chat passengers through the seat video display units; and
the flight system server is further configured to record the communication between the plurality of chat passengers as part of recording interactions between users of the seat video display units and the flight system server during a flight.

3. The system of claim 1 wherein:
the flight system server is further configured to record interactions between users of the seat video display units and the flight system server during each of a plurality of flights and record flight information for each of the plurality of flights and associate the recorded interactions with the recorded flight information for the flight during which the interactions were recorded.

4. The system of claim 3 wherein:
the flight system server is further configured to chose the advertisement to display on the at least one of the video display units during the current flight based on the recorded interactions associated with flight information that is correlated with flight information for the current flight.

5. The system of claim 1 wherein:
the flight system server is further configured to record summaries of interactions between users of the seat video display units and the flight system server during each of a plurality of flights, record flight information for each of the plurality of flights and associate the recorded summaries of interactions with the recorded flight information for the flight during which the interactions were recorded.

6. The system of claim 5 wherein:
the flight system server is further configured to chose the advertisement to display on the at least one of the video display units during the current flight based on the recorded summaries of interactions associated with flight information that is correlated with flight information for the current flight.

7. The system of claim 1 wherein:
the flight system server is further configured to identify users of the seat display units; and
the flight system server is further configured to record interactions between an identified user of the seat video display units and the flight system server during each of a plurality of flights, record flight information for each of the plurality of flights, and associate the recorded interactions with the identification of the user.

8. The system of claim 1 wherein the flight system server further comprises:
a content server unit;
a plurality of area distribution units connected to the content server unit via the network; and
a plurality of seatboxes connected to each of the area distribution units via the network, each seatbox being connected to a plurality of seat video display units.

9. The system of claim 8 wherein power is supplied to the seatboxes from the area distribution units using a power over network connection.

10. The system of claim 8 wherein each seatbox is connected to a plurality of area distribution units via the network.
